(19) United States
(12) Patent Application Publication
(10) Pub. No.: US 2003/0221111 A1
(43) Pub. Date: Nov. 27, 2003

(54) Portable authorization verification system

(76) Inventors: Michael W. Chasse, South Hero, VT (US); Joseph A. Parrott, Milton, VT (US)

Correspondence Address: ODONNELL LAW GROUP PLC, PO BOX 8471, BURLINGTON, VT, 05402-8471, US

(21) Appl. No.: 10/444,696

(22) Filed: May 23, 2003

Related U.S. Application Data
(60) Provisional application No. 60/383,436, filed on May 25, 2002.

(51) Int. Cl. H04L 9/00

(52) U.S. Cl. 713/185

(57) ABSTRACT

This invention is a portable system for verifying the authorization of individuals who are allowed access under a fixed door access control system. The invention is comprised of a portable case containing a manually operable input device. The input devise is connected to an access control unit in the same form as used in the fixed door access control system. The access control unit has a means for connecting to a central data base for updating the list of individuals who are authorized access. The access control device then signals whether access is authorized for a particular individual. The system is powered by a direct electrical connection or by means of a battery.

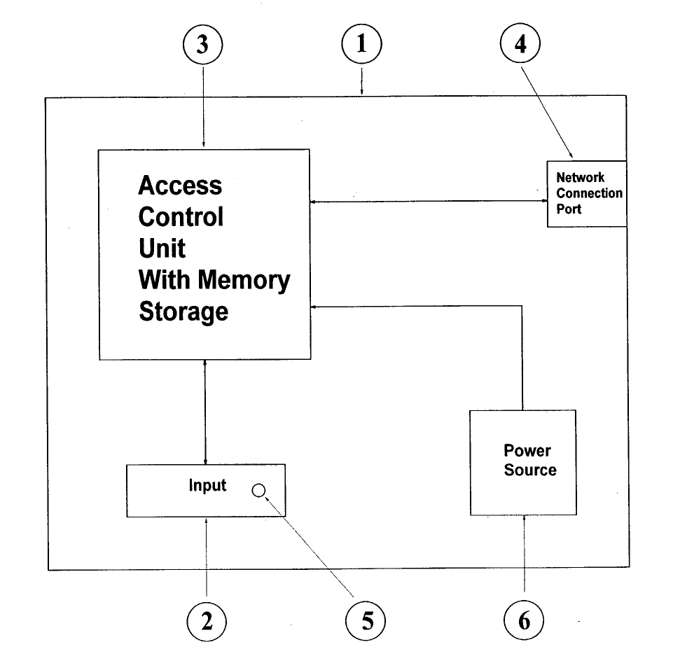

### BACKGROUND

Door access control systems are known for limiting access to buildings or facilities at colleges and universities, health care institutions and corporate campuses. Such known systems include a mounted door lock module coupled to an access control unit for authorization. Authorization is provided through a manually operable input device such as a keypad or card reader. Proper authorization results in the access control unit signaling the door lock module to unlock the respective door.

In many situations, an institution would like to limit access to the same individuals using a door access control system but at a location without mounted door lock modules. An example of such a situation would be a college limiting access to students only at a temporary structure such as a tent. Another example would be a university limiting access to students, faculty and staff only at a rented facility for a university-sponsored event.

### DESCRIPTION OF THE INVENTION

This invention is a portable system for verifying the authorization of individuals who are allowed access under a fixed door access control system. The invention is comprised of a portable case containing a manually operable input device. The input devise is connected to an access control unit in the same form as used in the fixed door access control system. The access control unit has a means for connecting to a central data base for updating the list of individuals who are authorized access. The access control device then signals whether access is authorized for a particular individual. The system is powered by a direct electrical connection or by means of a battery.

In one embodiment of the invention, a case with dimensions of approximately 0.5 meters×0.3 meters×0.2 meters would contain a card reader, access control unit, port for connecting to a telephone jack, battery power and authorization signal. The operator of the invention would use it to control access by requiring each individual to swipe his or her card through the card reader to verify authorization. The operator would periodically connect the access control unit, through a telephone line connection, to a central data base for updating the list of individuals who are authorized access under the fixed door access control system.

### DESCRIPTION OF THE DRAWING

In the drawing, the portable case (1) contains a manually operable input device (2). The input devise is connected to an access control unit (3) in the same form as used in the fixed door access control system. The access control unit has a means for connecting to a central data base (4) for updating the list of individuals who are authorized access. The access control device then signals (5) whether access is authorized for a particular individual. The system is powered by a direct electrical connection or by means of a battery (6).

We claim:

1. A portable authorization verification system, comprising
A manually operable input device in the same form as used in a fixed door access control system; connected to
An access control unit in the same form as used in a fixed door access control system; including
Means for connecting to a central data base for updating the list of individuals who are authorized access; and including
Means for indicating whether access is authorized; all of said system connected to Means for connecting to an external power source.

2. The portable authorization verification system as described in claim 1 wherein The power for the invention is supplied by an internal power source such as a battery.
